(19) United States
(12) Patent Application Publication
(10) Pub. No.: US 2026/0125017 A1
(43) Pub. Date: May 7, 2026

(54) BUMPER COVER STRUCTURE

(71) Applicant: TOYOTA JIDOSHA KABUSHIKI KAISHA, Toyota-shi (JP)

(72) Inventor: Eisuke IKENO, Toyota-shi (JP)

(73) Assignee: TOYOTA JIDOSHA KABUSHIKI KAISHA, Toyota-shi (JP)

(21) Appl. No.: 19/361,219

(22) Filed: Oct. 17, 2025

(30) Foreign Application Priority Data
Nov. 6, 2024 (JP) 2024-194657

(51) Int. Cl. B60R 19/18; B60R 19/48

(52) U.S. Cl. CPC B60R 19/18; B60R 19/483; B60R 2019/1886

(57) ABSTRACT

In a bumper cover of a front bumper, a radar unit is disposed between left and right grille portions in a grille opening portion, and a radar cover is disposed on a vehicle front side of the radar unit. The radar unit is attached to the base portion of a radar cover, and the base portion is attached to the bumper cover by each of an upper engagement portion and a lower engagement portion being engaged with upper and lower sides of the grille opening portion. As a result, since the relative position of the radar unit with respect to the grille opening portion is returned by the restoration of the shape of the bumper cover deformed by the light impact, the deterioration in the radar function of the radar unit can be suppressed.

### CROSS-REFERENCE TO RELATED APPLICATION

This application claims priority to Japanese Patent Application No. 2024-194657 filed on November 6, 2024. The disclosure of the above-identified application, including the specification, drawings, and claims, is incorporated by reference herein in its entirety.

### BACKGROUND

### 1. Technical Field

The present disclosure relates to a bumper cover structure of a vehicle.

### 2. Description of Related Art

Japanese Unexamined Patent Application Publication No. 2017-077804 (JP 2017-077804 A) discloses a front grille of a vehicle. The front grille is provided in front of a front member, and a millimeter wave radar is attached to the front member via a bracket. The front grille includes a radome holding portion fitted to an opening portion provided in a center portion in a vehicle width direction, and a radome made of a member through which radio waves can be transmitted is fitted to the radome holding portion. The millimeter wave radar is protected from disturbances such as wind, rain, snow, sand, and flying stones by covering the front with the radome.

### SUMMARY

In general, in a vehicle, a millimeter wave radar provided as a radar device used for monitoring a front of the vehicle emits radio waves (radar waves) toward the front of the vehicle through a grille opening portion provided in a bumper cover and receives reflected waves reflected by a target object in front of the vehicle. In this case, since the radar waves can be transmitted and received in an angle range set in advance, a required radar function by the millimeter wave radar is realized in the vehicle.

On the other hand, in the vehicle, the bumper cover of the bumper is deformed by receiving an impact, and the impact is absorbed by the bumper cover. In this case, in the millimeter wave radar, when the deformation occurs in the bumper cover or the like and the angle range in which the radar wave or the reflected wave is transmitted is changed, the required radar function is not realized.

From this, in the vehicle, a material having elasticity is used for a bumper cover or the like, and even when the bumper cover or the like is deformed by receiving an impact (light impact) that is less than the impact set in advance, a performance is guaranteed such that a shape of the bumper cover or the like is restored after the impact is released. Such a performance guarantee test of the bumper is inspected by a so-called pendulum test or the like.

However, in the millimeter wave radar, when the shape of the bumper cover or the like is restored, there is a concern that a relative position or the like with respect to the bumper cover or the like may be changed and the required radar function may not be maintained.

The present disclosure has been made in view of the problems, and an object of the present disclosure is to provide a bumper cover structure capable of suppressing a deterioration in the radar function of a radar device when a shape of the bumper cover structure is restored.

According to a first aspect of the present disclosure for achieving the object, there is provided a bumper cover structure including: a bumper cover body having a grille opening portion provided to penetrate the bumper cover body in a vehicle front-rear direction; a grille component disposed in the grille opening portion; a radar device disposed at a center portion of the grille component in a vehicle width direction on a vehicle rear side of the grille opening portion, emitting a radar wave toward a vehicle front side, and receiving a reflected wave of the radar wave; and a cover member disposed in the grille opening portion to cover the vehicle front side of the radar device, to which the radar device is attached, and having a vehicle upper side portion and a vehicle lower side portion each attached to the bumper cover body, the cover member allowing the radar wave and the reflected wave to be transmitted.

In the bumper cover structure according to the first aspect, the grille opening portion is provided in the bumper cover body, and the grille opening portion is provided to penetrate in the vehicle front-rear direction of the bumper cover body. In the grille opening portion, the grille components are disposed on both sides in the vehicle width direction, and the radar device is disposed at the center portion in the vehicle width direction. The radar device emits radar waves toward the vehicle front side and receives reflected waves of the radar waves on the vehicle rear side of the grille opening portion.

In addition, the cover member that covers the vehicle front side of the radar device and allows radar waves and reflected waves to be transmitted is disposed in the grille opening portion, and the radar device is attached to the cover member.

Here, each of an upper side portion and a lower side portion of the cover member is attached to the bumper cover body. Therefore, even in a case where the bumper cover body is deformed and the grille opening portion is deformed, a shape is restored, and thus the change in the relative position of the radar device with respect to the grille opening portion is suppressed. As a result, in a case where the shape of the deformed bumper cover body is restored, the deterioration in the radar function of the radar device can be suppressed.

According to a second aspect, in the bumper cover structure according to the first aspect, the cover member is attached to the bumper cover body on both sides in the vehicle width direction at each of the vehicle upper side portion and the vehicle lower side portion.

In the bumper cover structure according to the second aspect, the cover member is attached to the bumper cover body on the both sides in the vehicle width direction at each of the vehicle upper side portion and the vehicle lower side portion. As a result, in a case where the shape of the deformed bumper cover body is restored, since twisting of the cover member can be suppressed, it is possible to effectively suppress the deterioration in the radar function of the radar device due to the twisting of the cover member.

According to the aspect of the present disclosure, in the grille opening portion of the bumper cover body, each of the upper side portion and the lower side portion of the cover member to which the radar device is attached is attached to the bumper cover body. Therefore, the attachment position of the cover member is returned by the restoration of the shape of the bumper cover body by the elasticity after the bumper cover body receives the light impact. Therefore, there is an effect that the change in the relative position of the radar device and the like can be suppressed, and the deterioration in the radar function of the radar device can be suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view showing an outline of main parts of a bumper according to the present embodiment;

FIG. 2A is a perspective view showing the main parts of the bumper;

FIG. 2B is an exploded perspective view of the main parts of the bumper;

FIG. 3 is a cross-sectional view showing the outline of the main parts of the bumper when viewed from a vehicle width direction;

FIG. 4 is a cross-sectional view showing the outline of the main parts of the bumper when viewed from above;

FIG. 5A is a schematic view showing an outline of a radar cover when viewed from a vehicle front side; and

FIG. 5B is a schematic view showing the outline of the radar cover when viewed from a vehicle rear side.

### DETAILED DESCRIPTION OF EMBODIMENTS

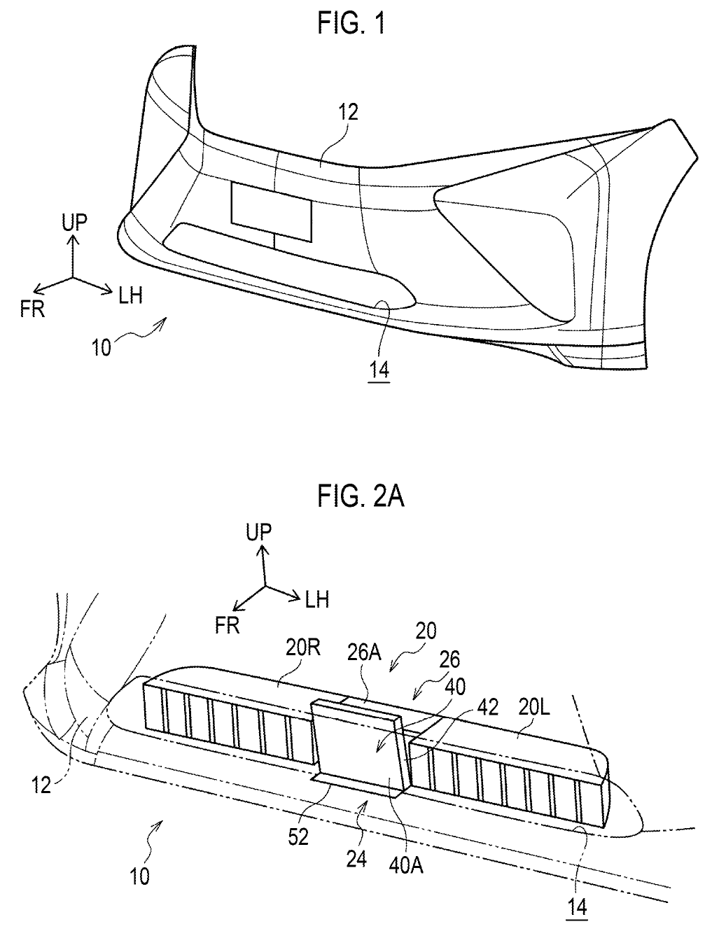

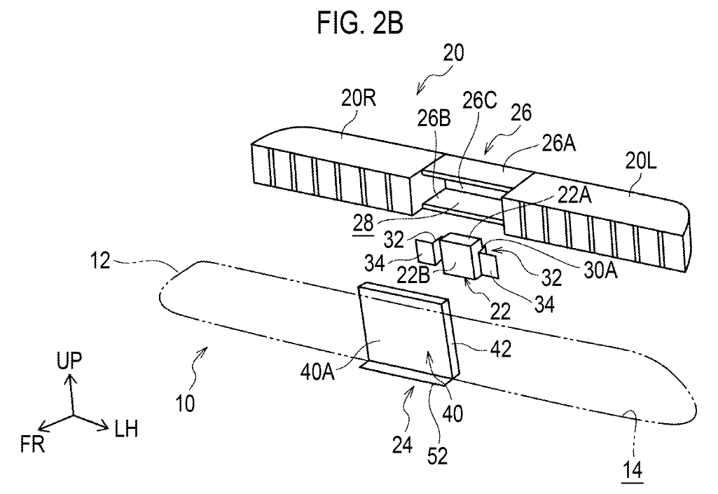

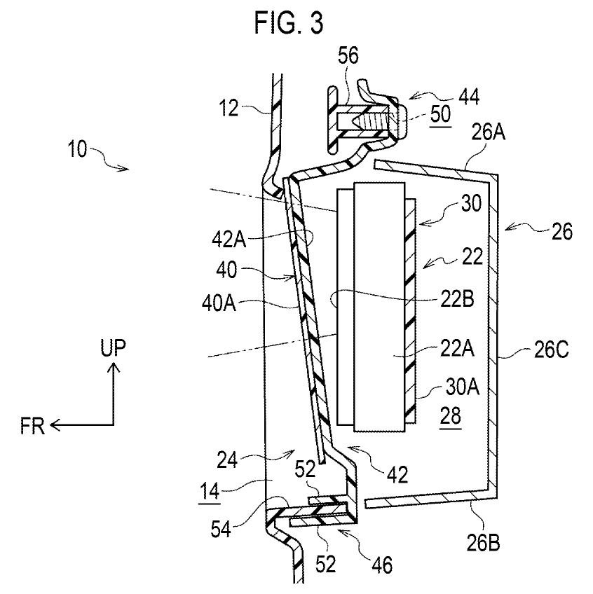

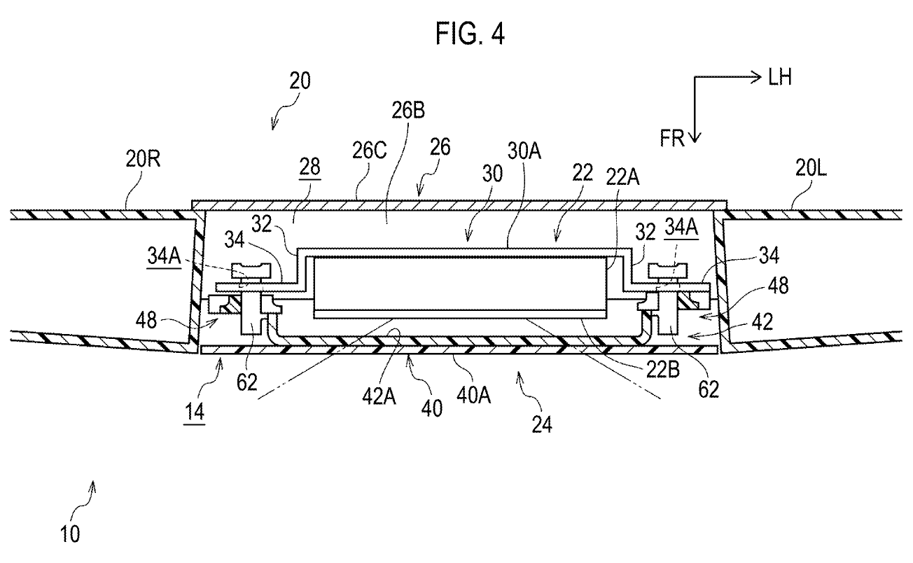

Hereinafter, a bumper cover structure disclosed in the present embodiment will be described using a front bumper 10 according to an embodiment as an example with reference to the drawings. The front bumper 10 is installed in a front portion of a vehicle (not shown). FIG. 1 is a perspective view showing an outline of the front bumper 10 according to the present embodiment when viewed from diagonally left front. Further, FIG. 2A is an exploded perspective view showing main parts of the front bumper 10 when viewed from diagonally left front, and FIG. 2B is a perspective view showing the main parts of the front bumper 10 when viewed from diagonally left front. Further, FIG. 3 is a cross-sectional view showing the main parts of the front bumper 10 when viewed from left side in a width direction, and FIG. 4 is a cross-sectional view showing the main parts of the front bumper 10 when viewed from above. In the drawings, the front side of the vehicle is indicated by an arrow FR, the left side in the vehicle width direction is indicated by an arrow LH, and the upper side is indicated by an arrow UP.

As shown in FIG. 1, FIG. 2A, and FIG. 2B, the front bumper 10 is constituted by a bumper cover (front bumper cover) 12 as a bumper cover body and a bumper reinforcement (front bumper reinforcement, not shown) constituting a vehicle body. In the front bumper 10, the bumper cover 12 is extended in the vehicle width direction on the vehicle front side of the bumper reinforcement. The bumper cover 12 is attached to the bumper reinforcement and covers the front portion of the vehicle including the bumper reinforcement.

The vehicle includes a hood that covers an engine compartment in which a traveling drive source, such as an engine or an electric motor, is disposed, and the front bumper 10 is disposed in front of each of left and right fenders on both sides (both not shown). The bumper cover 12 is connected to the hood and left and right fenders on both sides to form an outer plate (exterior) of the vehicle body and decorates the front portion of the vehicle body.

The bumper cover 12 is formed of a member having elasticity (resilience), and the bumper cover 12 is deformable by receiving an impact. In this case, the bumper cover 12 can be deformed while absorbing an impact energy (load due to the impact) when receiving an impact (hereinafter, referred to as a light impact) that is less than the impact set in advance, and the shape of the bumper cover 12 can be restored by releasing the impact energy (load).

As shown in FIGS. 1 to 4, the bumper cover 12 is provided with a grille opening portion 14 in an intermediate portion in the vehicle width direction. The grille opening portion 14 is an elongated oblong hole in the vehicle width direction, and the grille opening portion 14 is provided by penetrating the bumper cover 12 in the vehicle front-rear direction.

The bumper cover 12 is provided with a grille member 20 as a decoration member and a grille component, a radar unit 22 as a radar device, and a radar cover 24 as a cover member and the decoration member.

The grille member 20 includes a left grille portion 20L on the left side in the vehicle width direction, a right grille portion 20R on the right side in the vehicle width direction, and a connecting portion 26 at the center portion in the vehicle width direction, and the left grille portion 20L and the right grille portion 20R of the grille member 20 are connected by the connecting portion 26.

Each of the left grille portion 20L and the right grille portion 20R is formed in a long substantially box body shape, and each of surfaces on the vehicle front side is decorated in a mesh pattern or a lattice pattern. In addition, the connecting portion 26 includes a top plate 26A on the upper side, a bottom plate 26B on the lower side, and a back plate 26C on the vehicle rear side, and each of the top plate 26A, the bottom plate 26B, and the back plate 26C is an absorbent material (a resin material or a metal material) capable of shielding electromagnetic waves.

The grille member 20 includes the left grille portion 20L and the right grille portion 20R that are connected by the top plate 26A, the bottom plate 26B, and the back plate 26C of the connecting portion 26. As a result, a disposition portion 28 that is open toward the front of the vehicle by the connecting portion 26 that connects the left grille portion 20L and the right grille portion 20R is provided in the grille member 20. The connecting portion 26 may include a side plate in which the absorbent material is used, the side plate being attached to a right side surface (a surface on a right grille portion 20R side) of the left grille portion 20L and a left side surface (a surface on a left grille portion 20L side) of the right grille portion 20R.

As the radar unit 22, for example, a millimeter wave radar using a radio wave (electromagnetic wave) having a wavelength of 1 mm to 10 mm (a frequency of 30 GHz to 300 GHz) is applied as a radar wave. The radar unit 22 (millimeter wave radar) can detect, for example, position information such as a distance to a target object and a horizontal angle used for inter-vehicle distance control (adaptive cruise control (ACC)) or the like, by receiving reflected waves reflected by the target object.

The radar unit 22 includes a rectangular box body-shaped casing 22A, and, in the radar unit 22, one surface of the casing 22A is a sensor surface 22B. The radar unit 22 includes a transmitter and a receiver (not shown) on a sensor surface 22B side, and the radar unit 22 emits radar waves from the transmitter and receives reflected waves by the receiver.

The grille member 20 is provided with the radar unit 22 in the disposition portion 28 between the left grille portion 20L and the right grille portion 20R, and is provided with a bracket 30 as a holding member. As shown in FIGS. 3 and 4, the bracket 30 is, for example, a resin-made substantially plate-shaped, and is disposed between the left grille portion 20L and the right grille portion 20R (in the disposition portion 28) with the longitudinal direction being the vehicle width direction.

The bracket 30 has a flat portion 30A as an intermediate portion in the longitudinal direction, and leg portions 32 are provided on each of both sides of the flat portion 30A in the longitudinal direction. The leg portions 32 are projected from the flat portion 30A toward the vehicle front side, and the tip end side is bent to the outer side in the vehicle width direction. A flange 34 that is bent to the outer side in the vehicle width direction to be flat is provided in the leg portions 32. The flange 34 is provided with a through hole 34A that penetrates in the front-rear direction.

The bracket 30 is disposed in the disposition portion 28 with the flange 34 as the vehicle front side with respect to the flat portion 30A, and the radar unit 22 is attached to a vehicle front side surface of the flat portion 30A between the flanges 34. As a result, the radar unit 22 is disposed such that the sensor surface 22B side is directed forward of the vehicle and is disposed in the disposition portion 28.

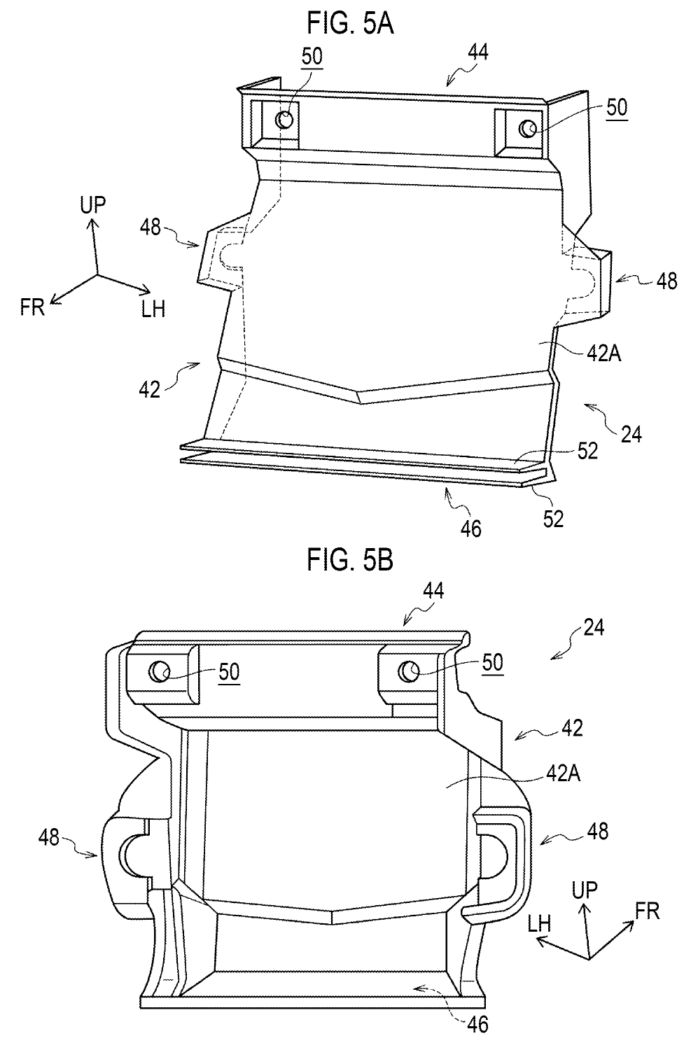

The radar cover 24 is disposed on the vehicle front side of the disposition portion 28 on which the radar unit 22 is disposed, and the disposition portion 28 is configured such that the vehicle front side is covered with the radar cover 24. FIG. 5A is a perspective view showing the outline of the radar cover 24 when viewed from diagonally left in the vehicle front side, and FIG. 5B is a perspective view showing the outline of the radar cover 24 when viewed from diagonally right on the vehicle rear side.

As shown in FIGS. 5A and 5B, the radar cover 24 includes, for example, a substantially flat plate-shaped decoration portion 40 and a base portion 42 to which the decoration portion 40 is attached. The decoration portion 40 and the base portion 42 are made of a material through which electromagnetic waves (radar waves and reflected waves) can be transmitted. Further, one surface of the decoration portion 40 is a decoration surface 40A, and the decoration surface 40A is provided with an emblem or the like and decorated thereto.

The base portion 42 of the radar cover 24 has a substantially rectangular shape as a whole with a flat portion 42A as a center portion, and the decoration portion 40 is attached to the vehicle front side surface of the flat portion 42A. The radar cover 24 is disposed between the left grille portion 20L and the right grille portion 20R by the base portion 42, so that the decoration portion 40 covers the base portion 42 between the left grille portion 20L and the right grille portion 20R in the grille opening portion 14.

As a result, in the bumper cover 12, the grille opening portion 14 is covered by the left grille portion 20L, the right grille portion 20R, and the decoration portion 40 of the radar cover 24, and is decorated by the left grille portion 20L, the right grille portion 20R, and the decoration portion 40. In addition, the radar unit 22 can transmit and receive radar waves and reflected waves through the decoration portion 40 of the grille opening portion 14 in the bumper cover 12.

The base portion 42 is provided with an engagement portion 44 used for engaging with the bumper cover 12 at the upper edge portion of the grille opening portion 14 and an engagement portion 46 used for engaging with the bumper cover 12 at the lower edge portion of the grille opening portion 14. That is, the base portion 42 is provided with the engagement portion 44 at the upper portion and the engagement portion 46 at the lower portion. In addition, the base portion 42 is provided with an engagement portion 48 on the right side and the left side in the vehicle width direction at an intermediate portion in the vertical direction, and the engagement portion 48 corresponds to the flange 34 of the bracket 30.

The engagement portion 44 at the upper portion of the base portion 42 is provided with engagement holes 50 that penetrate in the right side and the left side in the vehicle width direction. In addition, a pair of engagement plates 52 is provided up and down on the engagement portion 46 at the lower portion of the base portion 42, and each of the engagement plates 52 is projected to the vehicle front side at the lower end portion of the base portion 42 and extends in the vehicle width direction.

As shown in FIG. 3, the bumper cover 12 is provided with a bent portion 54 in which a lower peripheral edge portion of the grille opening portion 14 is bent to be substantially plate-shaped toward the vehicle rear side. The bent portion 54 of the bumper cover 12 is fitted between the engagement plates 52, so that an approximate domain of the base portion 42 at the lower portion in the vehicle width direction is engaged with the bumper cover 12.

In addition, the bumper cover 12 is provided with a stopping portion 56 above the vehicle rear side of the grille opening portion 14, and the stopping portion 56 is substantially cylindrical-shaped and is open to the vehicle rear side. The stopping portion 56 in the bumper cover 12 is provided to face each of the engagement portions 44 (engagement holes 50) of the base portion 42. The base portion 42 is engaged with the bumper cover 12 at the upper portion by screwing (or fitting) an engagement member (for example, a screw 58) that is fitted or screwed into the engagement hole 50 of the engagement portion 44 into the stopping portion 56. Further, the base portion 42 is provided with the engagement holes 50 on both sides in the vehicle width direction, so that both sides in the vehicle width direction are engaged with the bumper cover 12 at the upper portion.

The radar cover 24 is configured such that each of the engagement portions 44 of the base portion 42 is engaged with the bumper cover 12 at the upper side of the grille opening portion 14 in a state where the engagement portion 46 of the base portion 42 at the lower side is engaged with the bumper cover 12 at the lower peripheral edge portion of the grille opening portion 14. As a result, the radar cover 24 is attached to the bumper cover 12 on the vehicle front side of the disposition portion 28, and the decoration portion 40 is disposed in the grille opening portion 14.

The engagement portion 48 of the base portion 42 is projected to the vehicle rear side at each of the left side and the right side in the vehicle width direction, and the engagement portion 48 faces the flange 34 of the bracket 30. Each of the engagement portions 48 has an engagement hole 60 provided in a flat portion, and the engagement hole 60 is provided in a substantially semicircular shape that is open to the inner side in the vehicle width direction and penetrates the flat portion of the engagement portion 48 in the vehicle front-rear direction.

The bracket 30 is configured such that each of the flanges 34 faces the engagement portion 48 on the vehicle rear side of the base portion 42. In addition, the bracket 30 is attached to the base portion 42 by fitting an engagement member (for example, a grommet 62) that is fitted into the through hole 34A of the flange 34 into the engagement hole 60 of the engagement portion 48. As a result, the radar unit 22 attached to the bracket 30 is attached to the base portion 42 of the radar cover 24.

In the front bumper 10 configured as described above, the left grille portion 20L and the right grille portion 20R are disposed in the grille opening portion 14 of the bumper cover 12, and the decoration portion 40 of the radar cover 24 is disposed. The decoration portion 40 of the radar cover 24 is disposed between the left grille portion 20L and the right grille portion 20R. As a result, the bumper cover 12 is configured such that the grille opening portion 14 is decorated by the left grille portion 20L, the right grille portion 20R, and the decoration portion 40.

In addition, the radar unit 22 is disposed in the bumper cover 12. The radar unit 22 transmits radar waves and receives reflected waves reflected by the target object to detect position information such as presence or absence of the target object, a distance to the target object, and a horizontal angle of the target object.

The radar unit 22 is attached to the bracket 30, and the bracket 30 is attached to the base portion 42 of the radar cover 24. Further, the decoration portion 40 disposed in the grille opening portion 14 is attached to the radar cover 24. Therefore, in the bumper cover 12, the radar unit 22 can be disposed in the opening of the grille opening portion 14 and can be disposed in the vicinity of the decoration portion 40 in the opening of the grille opening portion 14.

Therefore, in the bumper cover 12, it is possible to widen the angle range (the range indicated by the two-dot chain line in FIGS. 3 and 4) in which the radar unit 22 can transmit and receive in the vertical direction and the vehicle width direction, and thus it is possible to widen the detection range of the radar unit 22. As a result, in the bumper cover 12, the detection range of the radar unit 22 can be expanded to improve the radar function.

In addition, in the vehicle, electromagnetic waves are generated in the engine compartment, and the electromagnetic waves may affect the operation of the radar unit 22 as noise.

In the bumper cover 12, the disposition portion 28 in which the radar unit 22 is disposed is surrounded by the metal top plate 26A, the bottom plate 26B, and the back plate 26C that constitute the connecting portion 26. The top plate 26A, the bottom plate 26B, and the back plate 26C can shield electromagnetic waves by being grounded. As a result, in the bumper cover 12, the electromagnetic wave in the engine compartment can be suppressed from affecting the radar unit 22 as noise. The detection error of the radar unit 22 due to the electromagnetic wave generated in the engine compartment can be suppressed, and the decrease in the radar function can be suppressed.

In the front bumper 10, when receiving a light impact, the bumper cover 12 is deformable while absorbing the impact energy, and the performance guarantee that the shape of the bumper cover 12 is restored by releasing the load due to the light impact is requested. In addition, in a case where a relative position or an orientation with respect to the grille opening portion 14 is changed, the radar function of the radar unit 22 is deteriorated.

From this, in the front bumper 10, when receiving a light impact, the shape of the bumper cover 12 is requested to be restored. In addition, in the bumper cover 12, when the shape is restored, the relative position of the radar unit 22 to the grille opening portion 14 is requested not to be changed. That is, the bumper cover 12 is requested to restore the shape even when a light impact is applied and to suppress a change in the relative position or the orientation of the radar unit 22 with respect to the grille opening portion 14 when the shape is restored.

For the performance quality test of the bumper cover 12 in response to such a request, for example, a pendulum test is applied. The bumper cover 12 is confirmed to have a performance quality in which the bumper cover 12 is deformed while absorbing the impact energy when the pendulum is collided with to receive a light impact, and the shape of the bumper cover 12 is restored when the pendulum is separated to release the impact (load).

Here, in the bumper cover 12, the bracket 30 is disposed in the disposition portion 28 between the right grille portion 20R and the left grille portion 20L, and the radar unit 22 is attached to the bracket 30. In addition, the bracket 30 is attached such that each of the flanges 34 on both sides in the vehicle width direction is engaged with the engagement portion 48 of the base portion 42 of the radar cover 24. Further, the base portion 42 is configured such that the engagement portion 44 at the upper portion is engaged with the bumper cover 12 above the grille opening portion 14, and the engagement portion 46 at the lower portion is engaged with the bumper cover 12 below the grille opening portion 14.

In the bumper cover 12 that satisfies the performance quality, the relative position of the radar unit 22 with respect to the grille opening portion 14 is changed by the deformation of the grille opening portion 14. Further, the shape of the grille opening portion 14 is restored, and thus the position of the radar unit 22 attached to the base portion 42 with respect to the grille opening portion 14 and the decoration portion 40 is returned.

Therefore, in a case where the bumper cover 12 receives a light impact, the relative position of the radar unit 22 to the grille opening portion 14 is returned, so that a deterioration in radar function of the radar unit 22 can be suppressed.

In addition, both end portions of the base portion 42 in the vehicle width direction are engaged with the bumper cover 12 in each of the engagement portion 44 and the engagement portion 46. As a result, in the radar cover 24, when the shape of the bumper cover 12 is restored, since the occurrence of twisting or the like in the base portion 42 is suppressed, the change in the angle range in the horizontal direction of the radar unit 22 due to the twisting of the base portion 42 is suppressed. Therefore, even in a case where the bumper cover 12 receives a light impact, the deterioration in the radar function of the radar unit 22 can be effectively suppressed.

Further, in the bumper cover 12, both sides of the bracket 30 in the width direction are attached to the base portion 42. Therefore, in the radar unit 22, when the shape of the bumper cover 12 is restored, the change in the angle range in the horizontal direction of the radar unit 22 is suppressed.

Therefore, in the bumper cover 12, when the shape is restored, the deterioration in the radar function of the radar unit 22 can be suppressed, and it is possible to stably detect the position information or the like of the target object by the radar unit 22.

In the present embodiment described above, a millimeter wave radar is used as the radar unit 22. However, the radar device may be applied with a light detection and ranging (LiDAR) using laser light that is considered to be electromagnetic waves having an extremely short wavelength.

In addition, in the present embodiment, the radar cover 24 to which the decoration portion 40 is attached is applied to the flat portion 42A of the base portion 42. However, an opening portion may be provided in the base portion 42 instead of the flat portion 42A, and the decoration portion 40 may be attached to cover the opening portion. In addition, the cover member may be formed integrally with the decoration portion 40 and the base portion 42.

Further, in the present embodiment, the front bumper 10 has been described as an example, but the bumper cover structure may be applied to a rear bumper installed at a rear portion of the vehicle.

What is claimed is:

1. A bumper cover structure comprising:
a bumper cover body having a grille opening portion provided to penetrate the bumper cover body in a vehicle front-rear direction;
a grille component disposed in the grille opening portion;
a radar device disposed at a center portion of the grille component in a vehicle width direction on a vehicle rear side of the grille opening portion, emitting a radar wave toward a vehicle front side, and receiving a reflected wave of the radar wave; and
a cover member disposed in the grille opening portion to cover the vehicle front side of the radar device, to which the radar device is attached, and having a vehicle upper side portion and a vehicle lower side portion each attached to the bumper cover body, the cover member allowing the radar wave and the reflected wave to be transmitted.

2. The bumper cover structure according to claim 1, wherein the cover member is attached to the bumper cover body on both sides in the vehicle width direction at each of the vehicle upper side portion and the vehicle lower side portion.
